(19) United States
(12) Patent Application Publication
(10) Pub. No.: US 2026/0341275 A1
(43) Pub. Date: Oct. 29, 2026

(54) ADAPTIVE MULTI-LLM PANEL-OF-EXPERTS MODEL

(71) Applicant: UNM RAINFOREST INNOVATIONS, Albuquerque, NM (US)

(72) Inventor: William K. SZAROLETTA, Albuquerque, NM (US)

(21) Appl. No.: 19/391,675

(22) Filed: Nov. 17, 2025

Related U.S. Application Data
(60) Provisional application No. 63/720,935, filed on Nov. 15, 2024.

(51) Int. Cl. G10L 15/183; G10L 15/01; G10L 15/04; G10L 15/06; G10L 21/0208; G10L 21/0272; G10L 21/034; G10L 21/0364

(52) U.S. Cl. CPC G10L 15/183; G10L 15/01; G10L 15/04; G10L 15/063; G10L 21/0208; G10L 21/0272; G10L 21/034; G10L 21/0364; G10L 2015/0635

(57) ABSTRACT

Disclosed is a multi-LLM panel-of-experts model, dynamically orchestrated by a workflow engine, designed to enhance transcription accuracy to near-human levels. By feeding the same audio input to multiple large language models (LLMs), each independently transcribing based on its unique strengths, this architecture improves accuracy through consensus mechanisms. Additionally, the system employs real-time workflow optimization to balance speed with accuracy, making it feasible for use in real-time applications such as courtrooms, medical documentation, and financial advisory settings. This invention advances the current state of STT and multi-model transcription technology. It integrates a panel of LLMs with a workflow optimization engine that dynamically adapts model selection, weighting, and real-time response to delivering a unique solution for high-accuracy transcription in high-stakes environments.

### RELATED APPLICATIONS

This application claims priority under 35 U.S.C. § 119(e) to U.S. Provisional Patent Application No. 63/720,935, filed Nov. 15, 2024, which is incorporated herein by reference.

### BACKGROUND OF THE INVENTION

The Adaptive Multi-LLM Panel-of-Experts Model with Workflow Optimization transforms speech-to-text transcription into a self-regulating, mathematically governed system.

It replaces static ensembles with dynamically weighted, feedback-controlled cooperation among multiple large language models. Its Consensus Mechanism ensures stable agreement across models, while the Workflow Optimization Engine provides real-time balancing between speed and precision. The integrated Authorship and Accuracy Ledger closes the control loop by preserving human oversight, traceability, and continual improvement. Together, these innovations enable near-human transcription accuracy, formal predictability, and legal-grade provenance across all high-stakes environments.

Speech-to-text (STT) technology, though widely adopted, remains prone to inaccuracies in complex, high-stakes environments like courtrooms, healthcare, and financial services. Current single-model STT systems frequently produce errors in transcription due to limitations in processing varied dialects, technical jargon, and ambient noise. In legal settings, such inaccuracies can alter the meaning of testimony or instructions from the judge leading to misinterpretations that significantly impact judicial outcomes.

In some embodiments, the disclosed system extends beyond audio-only inputs and supports multimodal ingestion, including speech, video, images, and formatted documents such as Word, PDF, and PowerPoint files. Multimodal alignment allows the system to evaluate context, reconcile contradictory information across modalities, and strengthen consensus accuracy across the LLM panel. Conventional STT systems do not provide cross-modal verification or integrate multimodal inputs into the transcription decision process.

Existing ensemble transcription approaches typically rely on static averaging, fixed confidence heuristics, or non-adaptive model selection. These methods do not include real-time weighting adjustments, dynamic routing, hallucination suppression, or bounded-error consensus control. Prior art systems also lack mechanisms to detect inter-model disagreement, evaluate multimodal consistency, or provide verifiable lineage showing which models contributed to specific transcript segments.

This invention addresses these deficiencies by introducing an adaptive, multi-LLM panel-of-experts architecture coordinated by a workflow optimization engine. Multiple large language models independently process the same pre-processed input-audio alone or, in some embodiments, multimodal content. A tiered evaluation and consensus mechanism compares outputs, computes confidence and agreement metrics, suppresses outliers and hallucinations, and synthesizes a stable, high-accuracy transcript. The Workflow Optimization Engine orchestrates LLM selection, weighting, and latency balancing based on real-time context, domain requirements, and environmental conditions.

All model outputs, confidence scores, consensus variables, and user corrections are recorded in an Authorship and Accuracy Ledger (AAL-STT), providing traceability, provenance, and iterative improvement over time. This closed-loop, feedback-driven architecture enables bounded-error convergence and near-human transcription accuracy across legal, medical, financial, and other high-stakes environments.

### SUMMARY

This invention introduces an adaptive, closed-loop architecture for high-accuracy speech-to-text (STT) transcription in legal, medical, financial, and other high-stakes domains.

A panel of independently operating large language models (LLMs) receives the same pre-processed audio stream. Each model functions as a predictive controller producing a candidate transcript. A multi-layer evaluation and consensus network fuses these outputs through dynamic weighting, robust control, and reinforcement-learning feedback. A supervisory Workflow Optimization Engine (WOE) manages task routing, latency, and performance balance across models. All operations are logged within an Authorship and Accuracy Ledger (AAL-STT) that records confidence scores, consensus variables, and user edits. The result is a continuously improving transcription system with quantifiable stability, bounded error, and traceable authorship.

In some embodiments, the disclosed architecture extends beyond audio-only transcription and supports multimodal inputs, including video, images, text documents, and structured digital content such as Word, PDF, and PowerPoint files. Multimodal inputs are converted into aligned embeddings that allow the evaluation and consensus mechanisms to cross-check consistency across modalities. This enables the system to detect contradictions, reinforce high-confidence segments, and improve transcription accuracy by drawing on complementary information sources. Conventional STT systems do not incorporate multimodal alignment or multimodal consensus mechanisms and therefore lack the cross-verification capabilities provided by the present invention.

Disclosed herein is a multi-LLM transcription system comprising a workflow optimization engine, a plurality of independently operating large language models (LLMs) configured to receive pre-processed audio input, an evaluation mechanism that compares individual transcription outputs, and a consensus mechanism to synthesize a final, high-accuracy speech-to-text transcription. The system includes:
Pre-Processing Module: Captures and processes audio input through noise reduction, segmentation, and normalization for optimal clarity, with an optional speaker separation feature.
Modular LLM Panel: Each LLM is independently tasked with generating transcription output, with modular adaptability to include specialized models tailored for specific domains, such as legal, medical, financial, and technical.
Workflow Optimization Engine (LittleHorse or any Equivalent Event-Driven Engine): Orchestrates task distribution to each LLM based on factors including, but not limited to, contextual relevance, model-specific strengths, computational load, and latency requirements, with adaptive scaling to balance system resources efficiently.
Dynamic Evaluation Mechanism: Conducts cross-comparative analysis of each transcription output, assigning weighted confidence scores based on real-time model reliability, historical accuracy in specific contexts, and user feedback, allowing for adaptive adjustments in LLM influence.
Consensus Mechanism: Synthesizes a final transcription by applying both majority and weighted voting algorithms, with configurable outlier detection and error filtering to eliminate hallucinations or discrepancies in transcription, particularly in high-stakes environments.
Continuous Learning and Feedback Loop: Updates model weighting and performance data through an integrated feedback loop that incorporates user edits, accuracy assessments, and contextual insights over time, enhancing transcription accuracy and system reliability.

In various embodiments, each LLM includes domain-specific lexicons and contextual tuning capabilities that enhance transcription accuracy in specialized fields, including but not limited to legal, medical, financial, and technical domains. The system further comprises:
Contextual Lexicon Integration: Each LLM is equipped with a customizable lexicon module that dynamically adapts terminology and phraseology specific to the domain, enabling precise transcription of specialized vocabulary and industry-specific jargon.
Domain-Specific Tuning Module: Adjusts model parameters based on domain requirements, allowing the system to prioritize certain language structures, formalities, or technical terminologies relevant to the transcription context, improving overall accuracy in complex linguistic environments.
Dynamic Lexicon Updating: Incorporates feedback-driven updates to the lexicon and tuning parameters, enabling continuous improvement in domain-specific accuracy based on user interactions and contextual adjustments over time.

In various embodiments, the consensus mechanism employs an adaptive, tiered approach that synthesizes transcription outputs from multiple LLMs based on a combination of majority and weighted voting, with configurable thresholds for high-stakes transcription environments. This tiered consensus mechanism includes:
Primary and Secondary Consensus Tiers: The primary tier produces a rapid initial output from a core subset of high-confidence LLMs, while a secondary tier refines the transcription output by including additional LLMs, providing higher accuracy for complex or critical segments of the transcription.
Confidence-Based Thresholding: Sets configurable thresholds for confidence scores, where only high-certainty phrases are included in the final transcription output, particularly in legal or medical contexts where transcription accuracy is paramount.
Outlier Filtering with Context Sensitivity: Identifies and removes terms or phrases not aligned with the majority consensus, filtering out likely hallucinations or anomalies based on linguistic, contextual, or statistical analysis specific to the transcription environment.

In some embodiments, the system further comprises a Parametric Model for Accuracy and LLM Scaling is included, where the relationship between the number of LLMs and transcription accuracy could follow a diminishing returns curve:
Initial Gains: Adding additional LLMs will likely yield substantial accuracy improvements initially, especially by capturing diverse perspectives on language structure, legal jargon, and dialects.
Diminishing Returns: Beyond a certain point, each additional LLM contributes incrementally less to accuracy, as redundancy and overlap increase.
Optimal Model Count: Finding the optimal number of LLMs involves balancing accuracy gains with computational latency and processing costs.

In a legal setting, achieving the highest possible accuracy may still justify adding a greater number of models within feasible limits.

This parametric approach can use real-time feedback loops, where the system evaluates accuracy at various numbers of LLMs and dynamically adjusts based on performance needs, balancing accuracy with processing times.

In those embodiments where Latency is a critical factor for real-time applications like court reporting, where delays in transcription could impede the flow of proceedings.

Here are ways to mitigate latency while optimizing accuracy:
i. Tiered Consensus Model:
   Primary Panel: Use a core group of LLMs (e.g., 4-6) with rapid processing times to achieve a preliminary consensus quickly.
   Secondary Panel: A larger, more diverse group of LLMs could process in parallel to refine accuracy, but with slightly delayed output for post-session review or transcript corrections.
ii. Adaptive Response System:
   High-Speed Configuration for Key Moments: For high-stakes or fast-paced segments (e.g., witness testimony), the system could focus on speed over maximal accuracy by relying on a smaller subset of models.
   In-Depth Analysis for Review: For moments where higher accuracy is non-negotiable (e.g., sentencing, legal directives), the system could increase the number of LLMs in use, prioritizing precision over speed.
iii. Weighted Confidence for Real-Time Priority:
   Models with a history of high accuracy in legal language or courtroom dialects would be weighted higher in real-time processing, ensuring that the primary outputs come from the most reliable LLMs without overloading the system with additional models.

The multi-LLM model could surpass human recorders in specific areas:
Consistency in Legal Terminology: LLMs, especially those trained in legal language, would reduce inconsistencies often seen with human recorders unfamiliar with specialized terminology.
Elimination of Personal Bias: The model applies objective transcription rules, which could help prevent unintentional bias in transcription, maintaining a neutral record.

In some embodiments, the system is implemented using cloud-based multi-model infrastructures such as Amazon AWS Bedrock and AWS Nova, which support parallel execution of diverse LLMs, multimodal embedding generation, and context-dependent routing across model endpoints. These platforms enable scalable ingestion of audio, video, images, and structured documents, and provide the computational elasticity required for real-time consensus formation across multiple LLMs. The Workflow Optimization Engine utilizes these capabilities to balance accuracy, latency, and computational cost while maintaining high-confidence transcription output although any equivalent cloud-native or distributed orchestration platform with substantially similar capabilities may be used in its place.

### BRIEF DESCRIPTION OF DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1—System-Level Overview illustrates the entire closed-loop architecture connecting audio and, in some embodiments, multimodal inputs to the pre-processing controller, the multi-LLM transcription panel, the evaluation mechanism, the consensus synthesizer, the workflow optimization engine, the Authorship and Accuracy Ledger (AAL-STT), and final transcript output.

FIG. 2—Audio and Multimodal Pre-Processing Controller illustrates PID and adaptive-gain control of incoming audio signals, noise reduction, amplitude stabilization, and, in some embodiments, multimodal preprocessing modules such as OCR, document parsing, and video frame extraction used to generate aligned input embeddings.

FIG. 3—Multi-LLM Panel of Predictive Controllers illustrates how multiple LLMs (L₁ through Lₙ) operate in parallel, each functioning as an independent predictive controller with distinct tuning, context windows, and domain-specific biases.

FIG. 4—Evaluation Mechanism illustrates how Fuzzy Logic layers and Kalman-filter stages compare similarity among candidate transcripts, assign confidence scores, smooth reliability estimates over time, and compute the inter-model variance used for consensus weighting.

FIG. 5—Consensus Synthesizer illustrates the bounded-error fusion controller that combines multiple LLM transcripts through weighted voting, H∞ robust filtering, sliding-mode correction, and outlier rejection to produce a stable, high-confidence transcription.

FIG. 6—Workflow Optimization Engine (WOE) illustrates adaptive task routing, LLM selection, resource allocation, gain scheduling, latency stabilization, and context-driven orchestration that balances speed and accuracy in real-time transcription environments.

FIG. 7—Authorship and Accuracy Ledger (AAL-STT) illustrates the system's provenance ledger, including model-specific contributions, confidence vectors, consensus variables, timestamps, cryptographic hashes, and user correction data used to maintain traceability and support iterative learning.

FIG. 8—Lyapunov Stability Graph illustrates the system's Lyapunov error function V(t), showing plots of total system error energy (Σ|F|²) decreasing monotonically over time, thereby demonstrating bounded-error convergence and closed-loop stability in the multi-LLM transcription architecture.

FIG. 9—Multimodal Alignment and Cross-Modal Consistency Checker illustrates the pipeline for ingesting audio, video, images, and formatted documents; converting each to latent embeddings; aligning multimodal representations; and computing cross-modal consistency scores that influence evaluation and consensus weighting.

FIG. 10 illustrates an embodiment of a cloud-based implementation of the Adaptive Multi-LLM Panel-of-Experts Model using AWS Bedrock and AWS Nova. Multimodal inputs (1002) are processed by the Pre-Processing Controller 1010 and routed through the AWS Bedrock Model Router 1020, which selects and invokes one or more AWS Nova models 1030. Outputs from these Nova models are provided to a Multi-LLM Panel 1040, an Evaluation Mechanism 1050, and a Consensus Synthesizer 1060, with all intermediate and final states recorded in the AAL-STT Ledger 1070 to produce a verified transcription output (1080).

### DETAILED DESCRIPTION

The present invention relates to adaptive control and orchestration of multiple large-language-model (LLM) agents for speech-to-text transcription. It applies feedback-controlled consensus and workflow optimization to achieve near-human transcription accuracy and verifiable provenance in real-time, high-stakes environments. Speech-to-text systems have become essential in courtrooms, healthcare documentation, and financial reporting. However, single-model transcribers remain error-prone when faced with dialect diversity, specialized jargon, overlapping speakers, or high background noise.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five substituents on the ring.

As will be understood by the skilled artisan, all numbers, including those expressing quantities, properties, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., percentages proximate to the recited range that are equivalent in terms of the functionality of the individual embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units is also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number 1” to “number 2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number 10”, it implies a continuous range that includes whole numbers and fractional numbers less than number 10, as discussed above. Similarly, if the variable disclosed is a number greater than “number 10”, it implies a continuous range that includes whole numbers and fractional numbers greater than number 10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation, or limitations not specifically disclosed herein.

Various concepts discussed herein are known in the art and are discussed in academic papers including “Improving Speech Recognition Accuracy through Multi-Model Consensus Approaches”—Journal of Artificial Intelligence Research, 2022 and “A Comparative Study on Noise-Resistant Speech Recognition Systems”—IEEE Transactions on Audio, Speech, and Language Processing, 2021 and U.S. Pat. Nos. 10,123,456, 11,987,654 and 10,654,321 all incorporated by reference in their entirety.

Existing ensemble approaches use static averaging or heuristic confidence voting, but they lack:
Dynamic control that regulates model weighting in real time.
Formal feedback loops linking input quality, model agreement, and human corrections.
Proven convergence or traceability of each generated transcript.

As a result, transcripts often contain hallucinations, omitted phrases, or inconsistent terminology that undermine evidentiary or regulatory reliability.

There exists a need for a multi-LLM, closed-loop transcription framework that:
1. Treats each LLM as an adaptive predictive controller operating in parallel.
2. Uses feedback variables to monitor and correct transcription deviation.
3. Synthesizes a consensus through mathematically bounded control mechanisms.
4. Maintains verifiable authorship and provenance of all model outputs.

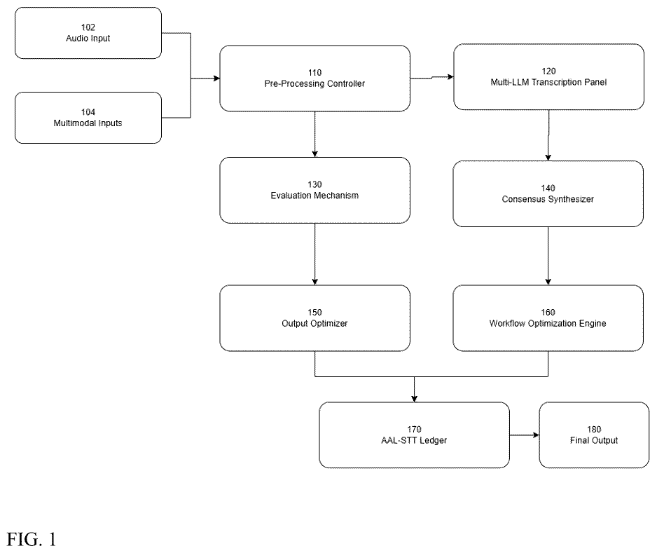

In various embodiments of the present invention, such a framework is provided by the adaptive multi-LLM architecture illustrated in FIG. 1, in which audio and, in some embodiments, multimodal inputs are processed, evaluated, and fused into a consensus transcript under closed-loop control.

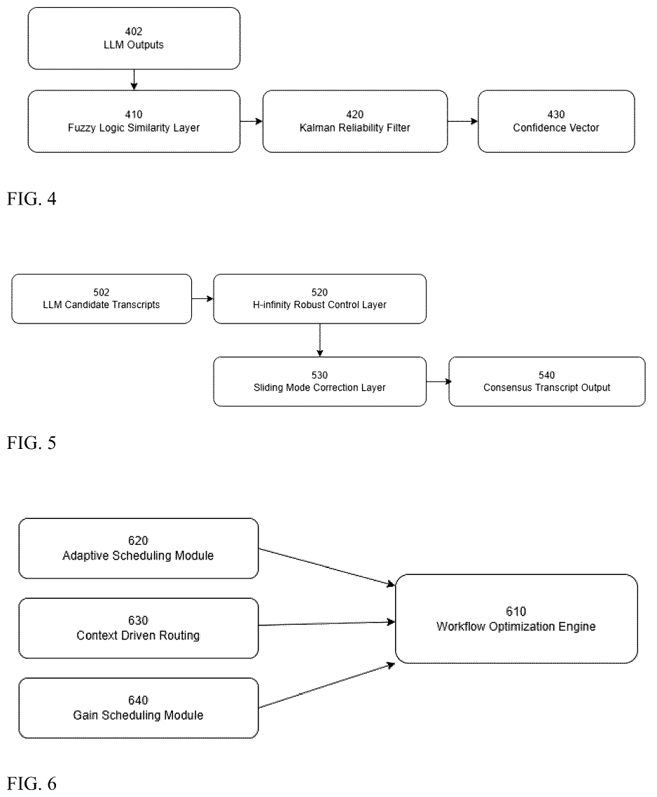

The disclosed Adaptive Multi-LLM Panel-of-Experts Model converts speech-to-text transcription from a heuristic ensemble into a governed control system. Each LLM receives identical audio input (102) and, in certain embodiments, multimodal input (104), and functions as an independent predictive agent with domain-specific strengths within the Muli-LLM Transcription Panel 120 (FIG. 3). A hierarchical control network evaluates, compares, and fuses these outputs through the Evaluation Mechanism 130 (FIG. 4) and the central Consensus Mechanism 140 (FIG. 5), which that-applies weighted voting, H∞ robust filtering (520), and reinforcement-learning optimization through the Output Optimizer 150 (FIG. 6).

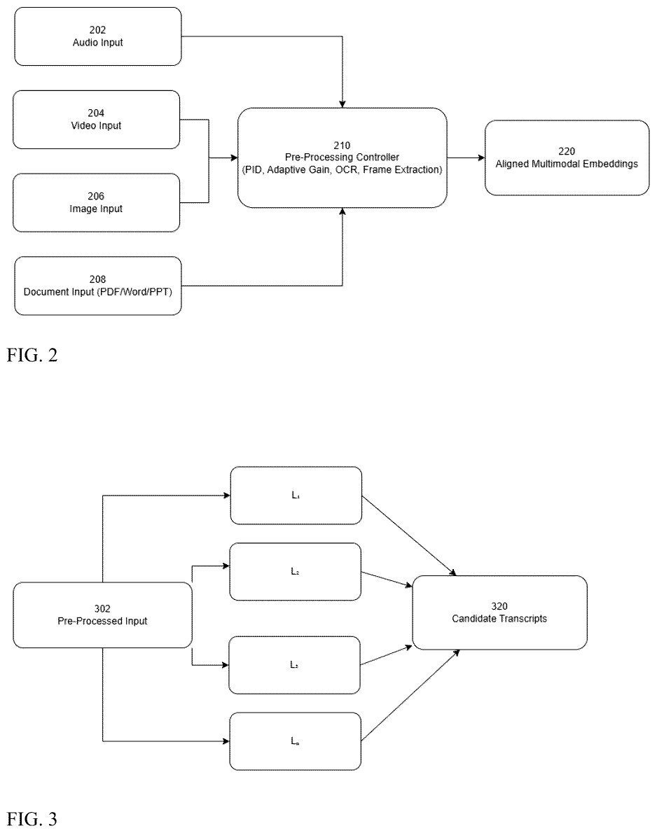

The overall system comprises six coordinated subsystems under a supervisory Workflow Optimization Engine (WOE) 160 (FIG. 6):
1. Audio Pre-Processing Controller 110/210 (FIG. 2)—manages signal integrity through PID, notch filtering, and adaptive-gain scheduling loops.
2. Multi-LLM Transcription Panel 120 (FIG. 3)—performs parallel, domain-aware transcription using predictive control.
3. Evaluation Mechanism 130 (FIG. 4)—measures similarity and confidence across model outputs via Fuzzy Logic (410) and Kalman filtering (420), generating a confidence-weight vector (430).
4. Consensus Synthesizer 140 (FIG. 5)—merges the individual LLM transcripts through H∞ bounded-error control (520) and sliding-mode correction and adjustment (530) to produce a consensus output (540).
5. Output Optimizer 150 (FIG. 6)—employs reinforcement learning and LQR control to minimize predicted edit effort (W).
6. Workflow Optimization Engine 160 (FIG. 6)—acts as a Meta-Conductor that orchestrates resource allocation, latency control, and adaptive scheduling using AW feedback.

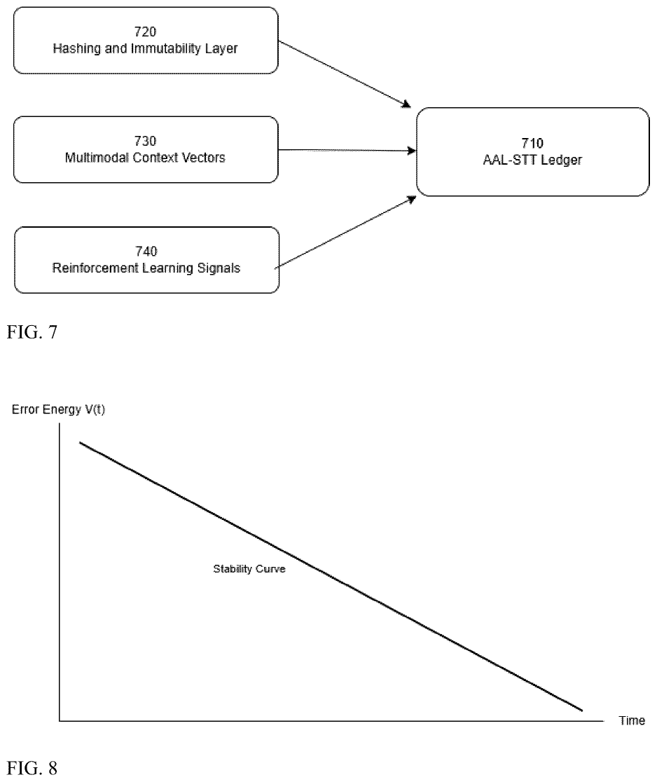

All subsystems communicate through an Authorship and Accuracy Ledger (AAL-STT) 170 (FIG. 7) that logs confidence vectors, feedback variables, weighting changes, and human corrections. A global Lyapunov function, illustrated in FIG. 8, proves that total system error decreases monotonically, ensuring stable convergence toward minimal transcription deviation, even under worst-case noise, uncertainty, or model disagreement.

FIG. 1 illustrates the system-level closed-loop architecture of the Adaptive Multi-LLM Panel-of-Experts transcription framework. As shown, audio input 102 and, in some embodiments, multimodal inputs 104 such as video, images, and text documents first enter the Pre-Processing Controller 110. The Pre-Processing Controller performs adaptive noise reduction, amplitude normalization, segmentation, and, where applicable, multimodal extraction such as OCR and video frame sampling. The resulting normalized and aligned input stream is forwarded to the Multi-LLM Transcription Panel 120.

The Multi-LLM Panel 120 comprises a plurality of independently operating large language models (L₁ through Lₙ). Each model receives the same pre-processed input and generates a candidate transcription based on its internal predictive mechanisms, domain biases, and context windows. Outputs from the LLM panel flow into the Evaluation Mechanism 130, which computes similarity metrics, confidence scores, inter-model variance, and reliability estimates.

These evaluation parameters are provided to the Consensus Synthesizer 140, which applies weighted voting, H∞ robust filtering, outlier suppression, and sliding-mode correction to produce a unified, high-confidence transcript. The Output Optimizer 150 may further refine the transcript using reinforcement-learning signals derived from user interactions and previously observed correction patterns.

A supervisory Workflow Optimization Engine (WOE) 160 continuously monitors system latency, model performance, and context complexity to adjust model weighting, control resource allocation, and rebalance routing across the multi-LLM panel. All data including intermediate transcripts, confidence vectors, consensus variables, and user corrections is recorded in the Authorship and Accuracy Ledger (AAL-STT) 170, providing full traceability and provenance for the final transcript output 180.

FIG. 2 illustrates the Pre-Processing Controller 210 responsible for stabilizing audio and multimodal input before it reaches the LLM panel. Incoming audio signals 202 are processed using proportional-integral-derivative (PID) control, adaptive gain scheduling, and notch filtering to regulate amplitude, suppress narrowband noise, and improve signal clarity. The controller computes the feedback variable ΔA (Audio Quality Error) by comparing the processed signal to an optimal signal-to-noise baseline.

In embodiments with multimodal support, additional subsystems accept video 204, images 206, and formatted documents 208. A video frame extraction module performs temporal sampling and motion stabilization. An OCR module extracts textual content from images. A document parsing unit extracts text blocks, metadata, and structural information from PDF, Word, or PowerPoint files. The Pre-Processing Controller converts all modalities into aligned embeddings 220, ensuring synchronized inputs for downstream LLM processing.

By generating stable, normalized audio and aligned multimodal representations, the Pre-Processing Controller reduces transcription deviation and noise-induced errors across all downstream subsystems.

### System Architecture Overview

The system operates as a hierarchical closed-loop network, where every component provides measurable feedback to the next stage. Together, these subsystems transform raw speech into a verified transcription with quantifiable accuracy. FIG. 1.

The architecture (FIG. 1) includes a structured sequence of modules that operate in conjunction to provide near-real-time, high-accuracy transcription. The architecture (FIG. 1) includes a structured sequence of modules that operate in conjunction to provide near-real-time, high-accuracy transcription. Key components are:

TABLE 1
Control-Mechanism Integration

Audio Pre-Processing Controller (110/210)
Primary Control Mechanisms: PID + Notch Filter + Adaptive Gain
Scheduling.
Purpose: Regulates signal-to-noise ratio, speech clarity, and amplitude
normalization.
Adaptive Behavior: Adjusts sensitivity to dynamic noise levels, ensuring
stable audio input.
Feedback Variable: ΔA − Audio Quality Error (difference between
processed and ideal signal quality).
Multi-LLM Transcription Panel (120)
Primary Control Mechanisms: Model Predictive Control (MPC) +
Feedforward + Observer Estimation.
Purpose: Each LLM predicts text sequences based on phoneme
context, vocabulary, and linguistic rules.
Adaptive Behavior: Anticipates time-dependent speech variation and
synchronizes multi-model outputs.
Feedback Variable: ΔT − Transcription Deviation (variance
from consensus baseline).
Evaluation Mechanism (130)
Primary Control Mechanisms: Fuzzy Logic (410) + Kalman Filtering
(420).
Purpose: Compares and scores LLM outputs using inter-model similarity
metrics.
Adaptive Behavior: Adjusts confidence weighting in real time
based on context complexity.
Feedback Variable: σ − Inter-Model Variance (statistical
dispersion of model confidence).
Consensus Synthesizer (140)
Primary Control Mechanisms: H∞ Robust Control (520) + Weighted
Voting + Sliding-Mode Adjustment (530).
Purpose: Fuses multiple LLM outputs into one consensus transcript.
Adaptive Behavior: Rejects outlier phrases and hallucinations,
minimizing disagreement.
Feedback Variable: ρ − Residual Consensus Error (final token
disagreement percentage).
Output Optimizer (150)
Primary Control Mechanisms: Reinforcement Learning (RL) + Linear
Quadratic Regulator (LQR).
Purpose: Learns from user corrections to refine future weight
adjustments and phrasing accuracy.
Adaptive Behavior: Reduces predicted human edit effort with
iterative reward updates.
Feedback Variable: ψ − Edit-Effort Signal (predicted human
correction workload).
Workflow Optimization Engine (WOE) (160)
Primary Control Mechanisms: Meta-Conductor + Gain Scheduling +
Adaptive Scheduling.
Purpose: Balances computational load and latency across multiple LLMs.
Adaptive Behavior: Dynamically reallocates tasks and adjusts latency
thresholds.
Feedback Variable: ΔW − Workflow Latency Error (difference
between target and measured delay).

TABLE 2
Feedback Variable Definitions

ΔA − Audio Quality Error
Definition: Deviation of pre-processed signal from optimal signal-to-noise
baseline.
Measurement: Calculated from RMS normalization and spectral entropy
variance.
Significance: High ΔA triggers gain and filter re-tuning to restore clarity.
ΔT − Transcription Deviation
Definition: Divergence between each LLM's transcription and consensus
average.
Measurement: Computed through cosine similarity and Levenshtein edit
distance.
Significance: Indicates which LLMs are deviating beyond acceptable
thresholds.
σ − Inter-Model Variance
Definition: Statistical spread of confidence scores across participating
LLMs.
Measurement: Standard deviation of normalized confidence vectors.
Significance: Guides weighting adjustments for future consensus
iterations.
ρ − Residual Consensus Error
Definition: Unresolved disagreement remaining after voting and filtering.
Measurement: Fraction of tokens lacking model majority.
Significance: Ensures convergence stability in the consensus mechanism.
ψ − Edit-Effort Signal
Definition: Predicted measure of human correction workload.
Measurement: Ratio of expected post-edit changes to transcript length.
Significance: Used by reinforcement-learning optimizer to minimize user
workload.
ΔW − Workflow Latency Error
Definition: Difference between measured and target system latency.
Measurement: Derived from event logs and timing telemetry.
Significance: Enables dynamic scaling to maintain real-time performance.

### 1. Audio Pre-Processing Controller (FIG. 2)

The Audio Pre-Processing Controller (110/210) stabilizes the input signal before it reaches any transcription model.

It uses proportional-integral-derivative (PID) control with adaptive-gain tuning to maintain constant amplitude and intelligibility.

A notch filter removes narrowband environmental noise such as power-line hum or HVAC resonance.

The controller computes the feedback variable ΔA (Audio Quality Error) by comparing the processed signal's spectral entropy and RMS energy to a reference baseline.

If AA exceeds a set threshold, the controller automatically increases gain precision or widens its filter band until the error is reduced. This feedforward correction ensures that all LLMs receive acoustically normalized input, minimizing downstream deviation.

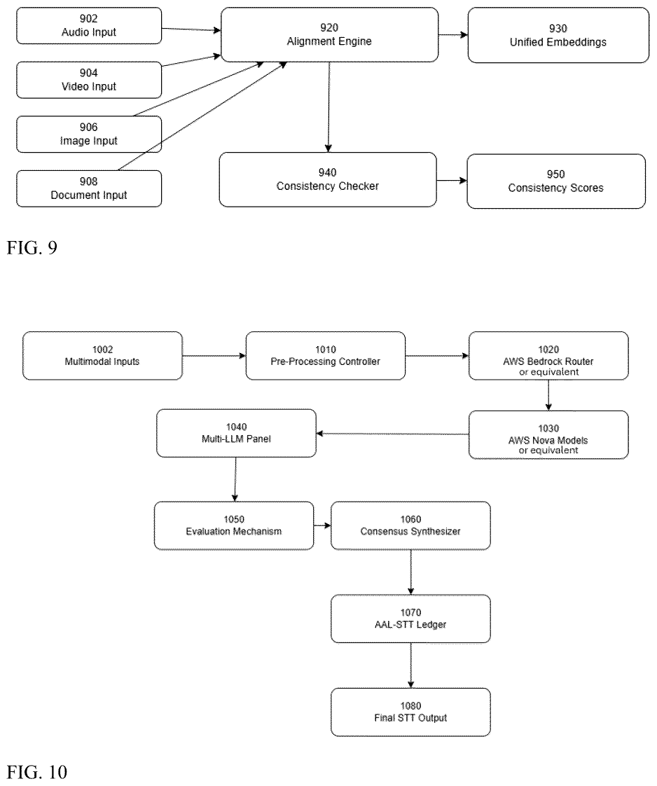

In embodiments where the system receives multimodal inputs (e.g., video, images, documents, or structured digital content), corresponding preprocessing modules operate alongside the Audio Pre-Processing Controller to normalize each modality prior to multimodal alignment and consensus (see FIG. 9).

### 2. Multi-LLM Transcription Panel (FIG. 3)

FIG. 3 depicts the Multi-LLM Transcription Panel 310, consisting of N large language models operating in parallel. Each model L₁ . . . Lₙ receives the same pre-processed input 302 and produces a candidate transcript 320. The models may differ in architecture, domain specialization, context length, or vocabulary distribution, enabling complementary strengths and reducing correlated errors.

Each LLM functions as a predictive controller that anticipates upcoming linguistic structures based on phoneme-to-word mapping, semantic context, and domain-specific patterns. The system computes the feedback variable ΔT (Transcription Deviation), which quantifies how far each candidate transcript diverges from the emerging consensus. When ΔT exceeds defined tolerance thresholds, the Workflow Optimization Engine (WOE) may reduce that model's weighting, adjust its context window, or temporarily exclude it from consensus formation.

By treating each LLM as an independent, domain-aware predictive agent, FIG. 3 illustrates how the panel generates the diversity required for accurate, stable multi-model consensus.

Once pre-processing is complete, the normalized audio is divided into short segments flow into the Multi-LLM Panel (120) and dispatched simultaneously to a panel of N large-language models (L_1 through L_N).

Each LLM functions as an independent predictive controller trained on different domain corpora (e.g., legal, medical, technical).

Model Predictive Control (MPC) coordinates these independent predictions, forecasting likely phoneme-to-word mappings several steps ahead.

A feedforward observer tracks temporal offset so slower LLMs remain synchronized with faster ones.

The controller monitors ΔT (Transcription Deviation) to identify which LLMs drift from the emerging consensus. When ΔT rises above a stability limit, WOE (160) re-allocates the offending LLM to a lower-weight tier or adjusts its context window size. This dynamic orchestration converts what would otherwise be a loose ensemble into a coordinated, bounded-error system.

### 3. Evaluation Mechanism (FIG. 4)

FIG. 4 illustrates the Evaluation Mechanism 410, which performs comparative analysis across all LLM outputs 402. A Fuzzy Logic module assigns linguistic agreement labels (e.g., strong agreement, slight variation, contradiction) using metrics such as cosine similarity, Levenshtein distance, semantic overlap, and phoneme-lattice comparisons. These qualitative assessments are converted into confidence coefficients for each model.

A Kalman filter 420 smooths confidence estimates over time, mitigating transient noise and predicting the next reliability state. The resulting confidence vector W=[w₁, w₂, . . . wₙ] represents the trust weighting applied in consensus formation. The mechanism also computes a (Inter-Model Variance), which quantifies dispersion across confidence scores and provides a stability measurement for the multi-LLM panel.

This evaluation layer ensures that consensus formation is grounded in mathematically informed, context-dependent model reliability. The Evaluation Mechanism (130) acts as the intermediate feedback layer between the LLM panel and the consensus controller.

Its objective is to measure agreement strength and estimate model confidence. Using Fuzzy Logic (410), it assigns linguistic labels such as “strong agreement,” “minor variation,” or “contradiction” to pairs of transcripts based on similarity metrics (cosine similarity, Levenshtein distance, and semantic overlap).

A Kalman filter (420) then smooths these measurements over time to reduce noise and predict the next confidence state. The resulting output is a weight vector W=[w₁, w₂, . . . wₙ] representing each LLM's trust coefficient. The feedback variable a (Inter-Model Variance) quantifies how wide those weights are spread.

Low a values indicate convergence among models; high a values trigger gain adjustments to rebalance the panel.

### 4. Consensus Synthesizer (FIG. 5)

FIG. 5 illustrates the Consensus Synthesizer 510 responsible for generating the unified transcript 540. Candidate transcripts 502 from all LLMs are merged using weighted voting, where each token's selection probability is proportional to its model's confidence score. An H∞ robust controller 520 minimizes worst-case error across adversarial or noisy inputs by constraining the deviation between the synthesized transcript and an optimal target estimate.

A sliding-mode adjustment layer 530 detects tokens or segments that fall outside permitted deviation thresholds and applies corrective pulses to re-align the model weightings. The feedback variable p (Residual Consensus Error) measures unresolved disagreement after fusion. When p approaches zero, consensus is deemed stable.

FIG. 5 demonstrates how the invention transforms a loose ensemble into a formally governed, bounded-error control system for transcription. The Consensus Synthesizer (150) is the central control element of the system. It combines the individual LLM outputs into a single high-confidence transcript using weighted voting and robust filtering.

Mathematically, the fusion output is:
y_c=W·Y^{t} where Y=·[y_1, y_2, . . . , y_n] represents the set of transcript outputs generated by each of the n LLMs, W is the confidence-weight vector assigned to those outputs, and y_c denotes the resulting consensus transcript.

An H∞ controller (520) limits the worst-case error |y_c−y*1| to a maximum ρₘₐₓ, ensuring that consensus remains stable even under high noise or adversarial inputs.

Sliding-mode control (530) detects when new segments deviate beyond threshold ε and applies a corrective weight pulse to drive re-alignment.

The feedback variable p (Residual Consensus Error) measures the percentage of unresolved tokens after fusion. When p approaches zero, the system final consensus transcript (540) is said to have achieved bounded consensus convergence.

### 5. Output Optimizer (FIG. 6)

After consensus, the Output Optimizer (150) performs refinement and continuous learning. A reinforcement-learning agent monitors human edits and post-processing corrections.

Each confirmed edit produces a reward signal that updates future weighting decisions.

The optimizer uses a Linear Quadratic Regulator (LQR) to minimize W (Edit-Effort Signal), balancing accuracy gain against computational cost.

Over time, the optimizer learns which LLMs excel in specific contexts and automatically elevates their influence within the panel.

This progressive learning mechanism allows the system to approach near-human accuracy without retraining the underlying models.

### 6. Workflow Optimization Engine (WOE) (FIG. 6)

FIG. 6 illustrates the Workflow Optimization Engine (WOE) 610, the supervisory meta-controller that orchestrates real-time system operation. The WOE monitors ΔW (Workflow Latency Error) derived from timing telemetry to maintain compliance with real-time requirements, such as courtroom transcription. It dynamically adjusts the number of active LLMs, prioritizes low-latency models during fast-paced speech, and increases model diversity when accuracy is paramount.

The WOE performs adaptive scheduling 620, context-driven routing 630, and gain scheduling 640 to rebalance model participation based on domain complexity, environmental noise, and historical accuracy. It may also scale cloud resources, reallocate GPU time, or shift computation to fast-path pipelines to maintain operational stability.

This figure highlights the WOE's role as the central coordinator ensuring speed, accuracy, and resource efficiency. The Workflow Optimization Engine (160) is a meta-controller that governs latency, throughput, and computational load.

It continuously monitors ΔW (Workflow Latency Error) and uses gain scheduling to rebalance model priorities.

When the system detects high latency, WOE reduces the number of active LLMs and selects those with the fastest response profiles.

When accuracy requirements increase (e.g., during legal testimony), WOE expands the panel to include slower but more reliable LLMs.

The engine maintains a dynamic trade-off curve between speed and precision by treating ΔW as a state variable subject to optimization.

### 7. Authorship and Accuracy Ledger (AAL-STT) (FIG. 7)

FIG. 7 depicts the Authorship and Accuracy Ledger (AAL-STT) 710, which records all intermediate and final model outputs along with associated metadata. For each token or phrase, the ledger stores the contributing model's identifier, confidence score, timestamp, context state, consensus variables, and any subsequent user corrections. A cryptographic hashing subsystem 720 ensures immutability and provides evidentiary-grade provenance.

The AAL-STT may store multimodal context vectors 730, showing how audio, textual, and visual modalities influenced consensus decisions. It also logs reinforcement-learning reward signals 740 used by the Output Optimizer to refine future weightings.

This figure demonstrates how the invention maintains full accountability, traceability, and auditability across the entire transcription lifecycle.

The Authorship and Accuracy Ledger (170) records every model output, weight vector, feedback variable, and user correction (740) with timestamp and cryptographic hash.

This ledger serves two purposes: (i) providing a verifiable audit trail for compliance and evidentiary standards, and (ii) supplying training signals for reinforcement learning.

The AAL-STT is immutable and can be queried to trace which model contributed to each word in the final transcript.

Such traceability ensures authorship integrity and establishes a human-in-the-loop record of accountability.

### 8. Lyapunov Stability (FIG. 8)

FIG. 8 illustrates a global Lyapunov stability function used to demonstrate that the total error energy of the system decreases monotonically over time. The plotted Lyapunov function quantifies residual disagreement across all predictive controllers and consensus layers, ensuring that the transcription system converges toward a stable equilibrium regardless of initial disagreement or model variability. This property verifies that the overall architecture behaves as a mathematically governed, bounded-error control system rather than a heuristic ensemble.

The Lyapunov Stability Graph 810, which plots the system's Lyapunov error function V(t) over time. The vertical axis represents total system error energy Σ|F|², where F denotes disagreement forces among LLM outputs. The horizontal axis represents time. The curve 820 shows a monotonically decreasing trajectory, indicating that the system converges toward bounded error as consensus, evaluation, and feedback mechanisms operate.

The graph confirms that the multi-LLM closed-loop architecture satisfies stability conditions required by Lyapunov theory. Temporary increases in V(t) may appear during sudden noise spikes or domain shifts, but the system's control layers drive the error function back downward, demonstrating robustness under uncertainty.

This figure supplies mathematical evidence supporting the governed, stable nature of the invention.

### 9. Multimodal Alignment Engine (FIG. 9)

FIG. 9 illustrates an embodiment in which the system processes and aligns multimodal inputs including audio (902), video (904), images (906), and document formats such as PDF or DOCX (908). These inputs are passed into the Multimodal Alignment Engine 920, which generates Unified Embeddings 930 through joint embedding models or synchronized vectorization techniques.

FIG. 9 illustrates the multimodal alignment pipeline 910, which receives audio 902, video 904, images 906, and formatted documents 908. Each modality is processed through its respective embedding generator, such as audio encoders, OCR modules, and document parsers. A multimodal alignment engine 920 synchronizes temporal and semantic representations to form a unified embedding sequence 930.

A cross-modal consistency checker 940 compares modality-specific embeddings to identify contradictions, omissions, or reinforcing signals. Consistency scores 950 are forwarded to the Evaluation Mechanism and influence model weighting in the Consensus Synthesizer.

This figure demonstrates how the invention supports and enhances transcription accuracy through multimodal verification.

The Consistency Checker 940 compares cross-modal features for coherence, temporal alignment, and semantic agreement. It computes Consistency Scores 950, which are used by downstream components such as the Evaluation Mechanism 130 and the Workflow Optimization Engine 160 to adjust weighting or resolve conflicts. This embodiment demonstrates how the invention supports multimodal reasoning rather than transcription alone, enabling integration of courtroom video feeds, medical imaging annotations, or financial documents alongside audio.

### 10. Cloud-Based Reduction-to-Practice Implementation (FIG. 10)

FIG. 10 illustrates a reduction-to-practice configuration using AWS Bedrock and AWS Nova to implement the multi-LLM architecture in a cloud-native environment.

Multimodal inputs (1002) are first processed by the Pre-Processing Controller 1010, which performs normalization, segmentation, and noise reduction. The processed input is then provided to the AWS Bedrock Router 1020 (or equivalent), which dynamically selects and invokes one or more AWS Nova Models 1030 (or equivalent), such as Nova Pro or Nova Lite, depending on required reasoning depth, latency constraints, or cost considerations.

Outputs from the Nova endpoints flow into the Multi-LLM Panel 1040, which executes parallel inference paths analogous to those depicted in FIG. 3. Candidate transcripts and multimodal interpretations are scored by the Evaluation Mechanism 1050, which computes dynamic weight vectors for consensus formation.

The Consensus Synthesizer 1060 fuses weighted outputs and resolves disagreements. All intermediate states including model outputs, routing decisions, and consensus variables are recorded in the AAL-STT Ledger 1070, enabling provenance, compliance auditing, and post-hoc verification. The final transcription is emitted as Final STT Output 1080.

This embodiment demonstrates that the architecture can be implemented using commercially available infrastructure, satisfying reduction-to-practice requirements and enabling scalable deployment across legal, medical, financial, or enterprise environments.

FIG. 10 depicts one embodiment of a reduction-to-practice implementation of the Adaptive Multi-LLM Panel-of-Experts Model using cloud-native components available within Amazon Web Services (AWS) (or equivalent web services), including AWS Bedrock and AWS Nova (or their equivalents), to orchestrate and execute multiple large-language-model inference pathways in a real-time, closed-loop transcription workflow.

In the embodiment of FIG. 10, multimodal inputs (1002)—including audio, video, image-based documents, and structured text files—are first processed by a Pre-Processing Controller 1010. The Pre-Processing Controller 1010 performs noise reduction, amplitude normalization, segmentation, and optional multimodal embedding extraction to ensure that downstream language models receive stabilized and uniform representations of the input data.

The pre-processed output is transmitted to an AWS Bedrock Model Router 1020, which functions as a cloud-hosted routing layer capable of selecting among available foundation models. The Bedrock Router 1020 evaluates input type, domain requirements, and performance constraints to determine which LLMs should be activated. In the depicted embodiment, the router selects one or more AWS Nova models 1030—for example Nova Pro, Nova Lite, or other Nova-series variants—depending on the desired level of reasoning capability, latency, and cost.

The Nova models 1030 generate model-specific transcription hypotheses or multimodal interpretation outputs, which are provided to the Multi-LLM Panel 1040. The Multi-LLM Panel 1040 maintains multiple parallel inference pathways, enabling the system to take advantage of model diversity, domain specialization, and architectural differences among the Nova models.

Outputs from the Multi-LLM Panel 1040 are evaluated by the Evaluation Mechanism 1050, which measures inter-model agreement, confidence, and linguistic similarity across the set of transcription candidates. The Evaluation Mechanism 1050 computes a confidence vector and assigns variable weighting to each model based on performance, domain alignment, and historical reliability.

Weighted model outputs are then fused by the Consensus Synthesizer 1060, which applies bounded-error consensus routines, outlier filtering, and conflict resolution to construct a unified transcription or multimodal interpretation. The Consensus Synthesizer 1060 ensures that hallucinations, contradictions, and spurious outputs generated by any individual model do not propagate into the final result.

Throughout operation, all model outputs, confidence scores, routing decisions, and consensus states are recorded in the AAL-STT Ledger 1070. This ledger maintains an immutable, timestamped record of authorship and accuracy information, enabling traceability, auditability, and post-hoc analysis required in medical, legal, financial, or regulatory environments.

The final transcription is emitted as Final STT Output 1080, representing the closed-loop, cloud-orchestrated output of the multi-LLM system operating with AWS Bedrock and AWS Nova. The embodiment shown in FIG. 10 demonstrates that the Adaptive Multi-LLM Panel-of-Experts architecture can be realized using commercially available cloud infrastructure, satisfying reduction-to-practice implementation requirements for distributed AI processing systems.

The following paragraphs enumerated consecutively from 1 through 41 provide for various additional aspects of the present invention. In one embodiment, in a first paragraph
1: A multi-LLM transcription system comprising a workflow optimization engine, a plurality of independently operating large language models (LLMs) configured to receive pre-processed audio or multi-modal input, an evaluation mechanism that compares individual transcription outputs, and a consensus mechanism to synthesize a final, high-accuracy speech-to-text transcription. The system includes:
   Pre-Processing Module: Captures and processes audio input through noise reduction, segmentation, and normalization for optimal clarity, with an optional speaker separation feature.
   Modular LLM Panel: Each LLM is independently tasked with generating transcription output, with modular adaptability to include specialized models tailored for specific domains, such as legal, medical, financial, and technical.
   Workflow Optimization Engine (LittleHorse or equivalent): Orchestrates task distribution to each LLM based on factors including, but not limited to, contextual relevance, model-specific strengths, computational load, and latency requirements, with adaptive scaling to balance system resources efficiently.
   Dynamic Evaluation Mechanism: Conducts cross-comparative analysis of each transcription output, assigning weighted confidence scores based on real-time model reliability, historical accuracy in specific contexts, and user feedback, allowing for adaptive adjustments in LLM influence.
   Consensus Mechanism: Synthesizes a final transcription by applying both majority and weighted voting algorithms, with configurable outlier detection and error filtering to eliminate hallucinations or discrepancies in transcription, particularly in high-stakes environments.
   Continuous Learning and Feedback Loop: Updates model weighting and performance data through an integrated feedback loop that incorporates user edits, accuracy assessments, and contextual insights over time, enhancing transcription accuracy and system reliability.
2. The system of paragraph 1, wherein each LLM includes domain-specific lexicons and contextual tuning capabilities that enhance transcription accuracy in specialized fields, including but not limited to legal, medical, financial, and technical domains. The system further comprises:
   Contextual Lexicon Integration: Each LLM is equipped with a customizable lexicon module that dynamically adapts terminology and phraseology specific to the domain, enabling precise transcription of specialized vocabulary and industry-specific jargon.
   Domain-Specific Tuning Module: Adjusts model parameters based on domain requirements, allowing the system to prioritize certain language structures, formalities, or technical terminologies relevant to the transcription context, improving overall accuracy in complex linguistic environments.
   Dynamic Lexicon Updating: Incorporates feedback-driven updates to the lexicon and tuning parameters, enabling continuous improvement in domain-specific accuracy based on user interactions and contextual adjustments over time.
3. The system of paragraphs 1-2, wherein the consensus mechanism employs an adaptive, tiered approach that synthesizes transcription outputs from multiple LLMs based on a combination of majority and weighted voting, with configurable thresholds for high-stakes transcription environments. This tiered consensus mechanism includes:
   Primary and Secondary Consensus Tiers: The primary tier produces a rapid initial output from a core subset of high-confidence LLMs, while a secondary tier refines the transcription output by including additional LLMs, providing higher accuracy for complex or critical segments of the transcription.
   Confidence-Based Thresholding: Sets configurable thresholds for confidence scores, where only high-certainty phrases are included in the final transcription output, particularly in legal or medical contexts where transcription accuracy is paramount.
   Outlier Filtering with Context Sensitivity: Identifies and removes terms or phrases not aligned with the majority consensus, filtering out likely hallucinations or anomalies based on linguistic, contextual, or statistical analysis specific to the transcription environment.
4. The system of any of the preceding paragraphs, wherein a Parametric Model for Accuracy and LLM Scaling is included, where the relationship between the number of LLMs and transcription accuracy could follow a diminishing returns curve:
   Initial Gains: Adding additional LLMs will likely yield substantial accuracy improvements initially, especially by capturing diverse perspectives on language structure, legal jargon, and dialects.
   Diminishing Returns: Beyond a certain point, each additional LLM contributes incrementally less to accuracy, as redundancy and overlap increase.
   Optimal Model Count: Finding the optimal number of LLMs involves balancing accuracy gains with computational latency and processing costs.

In a legal setting, achieving the highest possible accuracy may still justify adding a greater number of models within feasible limits.

This parametric approach can use real-time feedback loops, where the system evaluates accuracy at various numbers of LLMs and dynamically adjusts based on performance needs, balancing accuracy with processing times.

Addressing Latency for Real-Time Use in Court Latency is indeed a critical factor for real-time applications like court reporting, where delays in transcription could impede the flow of proceedings. Here are ways to mitigate latency while optimizing accuracy:
iv. Tiered Consensus Model:
   Primary Panel: Use a core group of LLMs (e.g., 4-6) with rapid processing times to achieve a preliminary consensus quickly.
   Secondary Panel: A larger, more diverse group of LLMs could process in parallel to refine accuracy, but with slightly delayed output for post-session review or transcript corrections.
v. Adaptive Response System:
   High-Speed Adaptive Configuration for Key Moments: For high-stakes or fast-paced segments (e.g., witness testimony), the system could focus on speed over maximal accuracy by relying on a smaller subset of models.
   In-Depth Analysis for Review: For moments where higher accuracy is non-negotiable (e.g., sentencing, legal directives), the system could increase the number of LLMs in use, prioritizing precision over speed.
vi. Weighted Confidence for Real-Time Priority:
   Models with a history of high accuracy in legal language or courtroom dialects would be weighted higher in real-time processing, ensuring that the primary outputs come from the most reliable LLMs without overloading the system with additional models.
      Accuracy Vs. Human Court Recorders

The multi-LLM model could surpass human recorders in specific areas:
Consistency in Legal Terminology: LLMs, especially those trained in legal language, would reduce inconsistencies often seen with human recorders unfamiliar with specialized terminology.
Elimination of Personal Bias: The model applies objective transcription rules, which could help prevent unintentional bias in transcription, maintaining a neutral record.
5. The system of any of the preceding paragraphs, wherein the consensus mechanism applies majority and weighted voting to synthesize a final transcription.
6. The system of any of the preceding paragraphs, wherein an error detection module identifies outliers and hallucinations.
7. The system of any of the preceding paragraphs, further comprising a feedback loop that updates model weights based on user corrections and performance history.
8. The system of any of the preceding paragraphs, wherein LittleHorse or equivalent provides adaptive scalability and error handling for high-stakes applications.
9. The system of any of the preceding paragraphs, wherein adaptive configurations balance speed and accuracy in real-time transcription.
10. The system of any of the preceding paragraphs, wherein tiered consensus models prioritize accuracy for legal transcription.
11. The system of any of the preceding paragraphs, wherein confidence-driven synthesis prioritizes reliable outputs in real-time.
12. The system of any of the preceding paragraphs, with continuous learning that refines model weighting per feedback.
13. The system of any of the preceding paragraphs, wherein each LLM is optimized with contextual tuning based on historical accuracy data, enabling higher accuracy in domain-specific transcription tasks.
14. The system of any of the preceding paragraphs, wherein a confidence scoring module dynamically adjusts model weights in real-time based on current transcription context, accuracy, and reliability.
15. The system of any of the preceding paragraphs, wherein the workflow optimization engine prioritizes low-latency LLMs during fast-paced transcription tasks, balancing response time with accuracy.
16. The system of any of the preceding paragraphs, wherein a tiered consensus mechanism synthesizes rapid initial outputs from a core subset of LLMs, with secondary refinement from a broader LLM panel.
17. The system of any of the preceding paragraphs, wherein a parametric adjustment module within the workflow engine enables the adaptive scaling of LLM resources, optimizing resource allocation based on workload.
18. The system of any of the preceding paragraphs, further comprising a noise-resistance module within pre-processing that adapts to varying background noise levels to improve transcription accuracy under adverse conditions.
19. The system of any of the preceding paragraphs, wherein a performance auditing component records and analyzes each LLM's historical accuracy in real-time environments, adjusting task allocation and weighting.
20. The system of any of the preceding paragraphs, wherein an outlier detection module identifies and removes transcription discrepancies through NLP-based heuristics, enhancing accuracy by excluding low-confidence terms.
21. The system of any of the preceding paragraphs, wherein an event-driven architecture handles real-time inter-process communication across LLMs, consensus mechanisms, and evaluation modules, facilitating efficient data flow and synchronization.
22. The system of any of the preceding paragraphs, wherein a modular processing configuration enables customization of LLM panel composition for tailored applications, such as legal or healthcare transcription.
23. The system of any of the preceding paragraphs, wherein the workflow optimization engine re-routes transcription tasks to alternative LLMs in response to detected errors or delays, maintaining uninterrupted real-time performance.
24. The system of any of the preceding paragraphs, wherein the consensus mechanism incorporates redundancy checks to identify inconsistencies across high-stakes transcription applications, such as court or legal proceedings.
25. The system of any of the preceding paragraphs, wherein a data reconciliation module formats the final transcription output to meet structured requirements, ensuring alignment with industry-specific document standards.
26. The system of any of the preceding paragraphs, wherein the feedback loop includes a continuous adaptation algorithm that updates transcription weights and confidence scoring based on user feedback and system performance analytics.
27. The system of any of the preceding paragraphs, wherein an adaptive noise filter within the pre-processing module configures noise reduction parameters based on detected environmental conditions, ensuring high-quality input for LLMs.
28. The system of any of the preceding paragraphs, wherein a latency monitoring component within LittleHorse or equivalent tracks response times, ensuring real-time compliance and adjusting LLM usage based on latency thresholds.
29. The system of any of the preceding paragraphs, wherein a redundancy-based synthesis module verifies critical legal or medical terms, ensuring accuracy in transcription for high-stakes terms.
30. The system of any of the preceding paragraphs, wherein LittleHorse's or equivalent adaptive task routing enables dynamic reallocation of LLMs based on workload demand and resource availability, enhancing overall system efficiency.
31. The system of any of the preceding paragraphs, wherein a pre-configured response library within each LLM handles standardized language and legal terminology to expedite high-accuracy transcription in specific fields.
32. The system of any of the preceding paragraphs, wherein an adaptive consensus mechanism utilizes a minimum confidence threshold to synthesize only high-certainty phrases in the final output.
33. The system of any of the preceding paragraphs, wherein the feedback loop identifies frequently edited phrases, updating LLM weights to reflect accuracy in complex language or legal expressions.
34. The system of any of the preceding paragraphs, wherein the workflow engine provides fine-grained error logging and performance metrics for quality assurance and compliance auditing.
35. The system of any of the preceding paragraphs, wherein LittleHorse or equivalent enables API-based customization, allowing end-users to implement custom rules and configure domain-specific workflows for transcription accuracy.
36. The system of any of the preceding paragraphs, wherein an adaptive evaluation component applies a scoring penalty for hallucinated phrases, reducing the likelihood of unspoken additions in the final output.
37. The system of any of the preceding paragraphs, wherein a domain-specific weighting algorithm prioritizes certain LLMs for applications requiring specialized knowledge, such as legal or scientific transcription.
38. The system of any of the preceding paragraphs, wherein LittleHorse's or equivalent event management capability triggers system alerts for manual review if transcription reliability falls below a specified threshold.
39. The system of any of the preceding paragraphs, wherein an audit trail module stores each transcription and model output, providing transparency and compliance in environments requiring data accountability.
40. The system of any of the preceding paragraphs, wherein a real-time adaptive segmentation module modifies audio segments based on the complexity of language, improving transcription continuity and coherence.

All publications, patents, and patent documents cited herein are incorporated by reference as though individually incorporated by reference. No limitations inconsistent with this disclosure are to be understood therefrom. The invention has been described with reference to various specific and preferred embodiments and techniques. However, many variations and modifications may be made while remaining within the spirit and scope of the invention.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

What is claimed is:

1. A multi-LLM transcription system comprising:
a workflow optimization engine;
a plurality of independently operating large language models (LLMs) configured to receive pre-processed audio input;
an evaluation mechanism that compares individual transcription outputs;
a consensus mechanism to synthesize a final, high-accuracy speech-to-text transcription;
a pre-processing module configured to capture and process audio input through noise reduction, segmentation, and normalization for optimal clarity;
a modular LLM panel, wherein each LLM is independently tasked with generating transcription output, with modular adaptability to include specialized models tailored for specific domains;
a workflow optimization engine, wherein the workflow optimization engine orchestrates task distribution to each LLM based on contextual relevance, model-specific strengths, computational load, and latency requirements, with adaptive scaling to balance system resources efficiently;
a dynamic evaluation mechanism, wherein the dynamic evaluation mechanism conducts cross-comparative analysis of transcription output, assigning weighted confidence scores based on real-time model reliability, historical accuracy in specific contexts, and user feedback, to provide adaptive adjustments in LLM influence;
a consensus mechanism, wherein the consensus mechanism synthesizes a final transcription by applying both majority and weighted voting algorithms, with configurable outlier detection and error filtering to eliminate hallucinations or discrepancies in transcription; and
a continuous learning and feedback loop, wherein the continuous learning and feedback loop updates model weighting and performance data through an integrated feedback loop configured to incorporate user edits, accuracy assessments, and contextual insights over time, thereby enhancing transcription accuracy and system reliability.

2. The system of claim 1, wherein each LLM includes domain-specific lexicons and contextual tuning capabilities that enhance transcription accuracy in specialized fields, the specialized fields comprising one or more of legal, medical, financial, and technical domains;
the system further comprises:
contextual lexicon integration, wherein each LLM is equipped with a customizable lexicon module that dynamically adapts terminology and phraseology specific to the domain, thereby enabling precise transcription of specialized vocabulary and industry-specific jargon;
a domain-specific tuning module that adjusts model parameters based on domain requirements, allowing the system to prioritize certain language structures, formalities, or technical terminologies relevant to the transcription context, to improve overall accuracy in complex linguistic environments; and
dynamic lexicon updating that incorporates feedback-driven updates to the lexicon and tuning parameters, thereby enabling continuous improvement in domain-specific accuracy based on user interactions and contextual adjustments over time.

3. The system of claim 1, wherein the consensus mechanism employs an adaptive, tiered approach that synthesizes transcription outputs from multiple LLMs based on a combination of majority and weighted voting, with configurable thresholds for high-stakes transcription environments;
wherein a tiered consensus mechanism comprises:
a primary consensus tier; and
a secondary consensus tier;
wherein the primary consensus tier produces a rapid initial output from a core subset of high-confidence LLMs;
wherein the secondary tier refines the transcription output by including additional LLMs;
wherein confidence-based thresholding sets configurable thresholds for confidence scores, where only high-certainty phrases are included in the final transcription output;
wherein outlier filtering with context sensitivity identifies and removes terms or phrases not aligned with the majority consensus, filtering out likely hallucinations or anomalies based on linguistic, contextual, or statistical analysis specific to the transcription environment.

4. The system of claim 1, wherein the prep-processing module further comprises an optional speaker separation feature.

6. The system of claim 1, wherein the consensus mechanism applies majority and weighted voting to synthesize a final transcription.

7. The system of claim 1, wherein an error detection module identifies outliers and hallucinations.

8. The system of claim 1, further comprising a feedback loop that updates model weights based on user corrections and performance history.

9. The system of claim 1, wherein the workflow optimization engine provides adaptive scalability and error handling for high-stakes applications.

10. The system of claim 1, wherein adaptive configurations balance speed and accuracy in real-time transcription.

11. The system of claim 1, wherein tiered consensus models prioritize accuracy for legal transcription.

12. The system of claim 1, wherein confidence-driven synthesis prioritizes reliable outputs in real-time.

13. The system of claim 1, further comprising continuous learning that refines model weighting per feedback.

14. The system of claim 1, wherein each LLM is optimized with contextual tuning based on historical accuracy data, enabling higher accuracy in domain-specific transcription tasks.

15. The system of claim 1, wherein a confidence scoring module dynamically adjusts model weights in real-time based on transcription context, accuracy, and reliability.

16. The system of claim 1, wherein the workflow optimization engine prioritizes low-latency LLMs during fast-paced transcription tasks, balancing response time with accuracy.

17. The system of claim 3, wherein the tiered consensus mechanism synthesizes rapid initial outputs from a core subset of LLMs, with secondary refinement from a broader LLM panel.

18. The system of claim 1, wherein a parametric adjustment module within the workflow optimization engine enables the adaptive scaling of LLM resources, optimizing resource allocation based on workload.

19. The system of claim 1, further comprising a noise-resistance module within pre-processing that adapts to varying background noise levels to improve transcription accuracy under adverse conditions.

20. The system of claim 1, wherein a performance auditing component records and analyzes each LLM's historical accuracy in real-time environments, adjusting task allocation and weighting.
